(19) United States
(12) Patent Application Publication
(10) Pub. No.: US 2012/0318107 A1
(43) Pub. Date: Dec. 20, 2012

(54) THREAD CHASER

(76) Inventor: Fred W. Mann, Waterville, KS (US)

(21) Appl. No.: 13/327,518

(22) Filed: Dec. 15, 2011

Related U.S. Application Data
(60) Provisional application No. 61/423,133, filed on Dec. 15, 2010.

(51) Int. Cl. B25B 7/22; B25B 7/04; B25B 7/14; B25B 7/02

(52) U.S. Cl. 81/319; 81/426.5; 81/422; 81/423

(57) ABSTRACT

A thread chaser device is provided for clearing, cleaning, and repairing damaged, dirty, or otherwise impaired threads on a threaded object, such as a bolt or other like objects. In a preferred embodiment, the thread chaser comprises half a die welded into both jaws of a wrench. Alternatively, the thread chaser may include removable die-blocks containing multiple half dies for use with bolts or threaded objects of various sizes and diameters. The thread chaser may optionally include a means for locking the jaws in a closed position around the threaded object.

### CROSS-REFERENCE TO RELATED APPLICATIONS

This application claims the benefit of U.S. provisional application No. 61/423,133 filed Dec. 15, 2010.

### BACKGROUND OF THE INVENTION

1. Field of the Invention

The present invention relates generally to a thread chaser for cleaning out and repairing damaged threads of a bolt or pipe, and in particular a device suitable for cleaning or repairing threads in obstructed areas whether the threads are right-handed or left-handed.

2. Description of the Related Art

A wide variety of devices are available for cutting and chasing threads of bolts and other like objects. The most common of these devices comprises a die that is gripped by a turning tool such as a conventional wrench, die stock, die handle or the like. The die is placed over the damaged thread and rotated by a turning tool to clean and repair the thread. Due to the size of many thread chasers and/or the radius of their turning device, damaged threads must be removed from operation in order to be repaired.

Heretofore there has not been available a thread chaser with the advantages and features of the present invention.

### SUMMARY OF THE INVENTION

In the practice of the present invention a thread chaser device is provided. Without limitation, the thread chaser is adapted for cleaning and repairing damaged threads on bolts or other like objects. In a preferred embodiment, the thread chaser comprises half a die welded into both jaws of a wrench.

### BRIEF DESCRIPTION OF THE DRAWINGS

The drawings constitute a part of this specification and include exemplary embodiments of the present invention illustrating various objects and features thereof.

FIG. 1 is an upper, front isometric view of a pliers thread chaser device comprising an embodiment of the present invention in an open position.

FIG. 2 is an upper, front isometric view of the pliers thread chaser in a closed position.

FIG. 3A is a cross-sectional view of the thread chaser engaged with a damaged thread.

FIG. 3B is a cross-sectional view of the thread chaser engaged with and repairing the damaged thread.

FIG. 3C is a cross-sectional view of the repaired thread and the thread chaser.

FIG. 4 is a side elevation of an adjustable-diameter thread chaser comprising an alternative embodiment of the present invention.

FIG. 5 is a side elevation of a multi-diameter thread chaser device in the jaws of a pair of locking pliers comprising an alternative embodiment of the present invention.

FIG. 6 is a side elevation of a multi-diameter thread chaser jaw removed from the locking pliers to show a rack and pinion mechanism comprising an alternative embodiment of the present invention.

FIG. 7 is a side elevation of a multi-diameter thread chaser jaw removed from the locking pliers to show the rack and pinion mechanism.

FIG. 8 is a top plan view of the multi-diameter thread chaser jaw.

FIG. 9 is a side elevation of a locking pliers thread chaser comprising an alternative embodiment of the present invention, shown with the jaws closed.

FIG. 10 is a side elevation of the locking pliers thread chaser, shown with the jaws open.

FIG. 11 is an enlarged, fragmentary view of the thread chaser taken generally within Circle 11 in FIG. 10 and showing a removable die.

FIG. 12 is an enlarged, cross-sectional view taken generally along line 12 in FIG. 11.

FIG. 13 is a side elevation of locking pliers comprising an alternative embodiment of the present invention.

### DETAILED DESCRIPTION OF THE PREFERRED EMBODIMENT

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment or Aspect of the Thread Chaser 2

Referring to the drawings in more detail, the reference numeral 2 generally designates a thread chaser embodying an aspect of the present invention. Without limitation on the useful applications of the thread chaser 2 comprising the present invention, an exemplary pliers thread chaser includes upper and lower handles 4, 6; a connection hinge 8; upper and lower jaws 16, 10; and upper and lower dies 14, 12. The improved features of the present invention over the prior art include the elimination of the need to remove the damaged thread for repair, the ability to use the present invention on either right or left hand threads, and the ability to use the present invention in tight or otherwise obstructed spaces. It should be noted that the present invention is not, however, limited to any or all of these features, or to the disclosed application.

The handles 4, 6 have gripping surfaces 36. The connection hinge 8 holds the thread chaser 2 together and is the pivot point about which the thread chaser 2 opens and closes. The dies 12, 14 can be welded or otherwise suitably fastened onto the jaws 10, 16. The dies 12, 14 include female threads 32 and debris channels 34.

### III. Operation

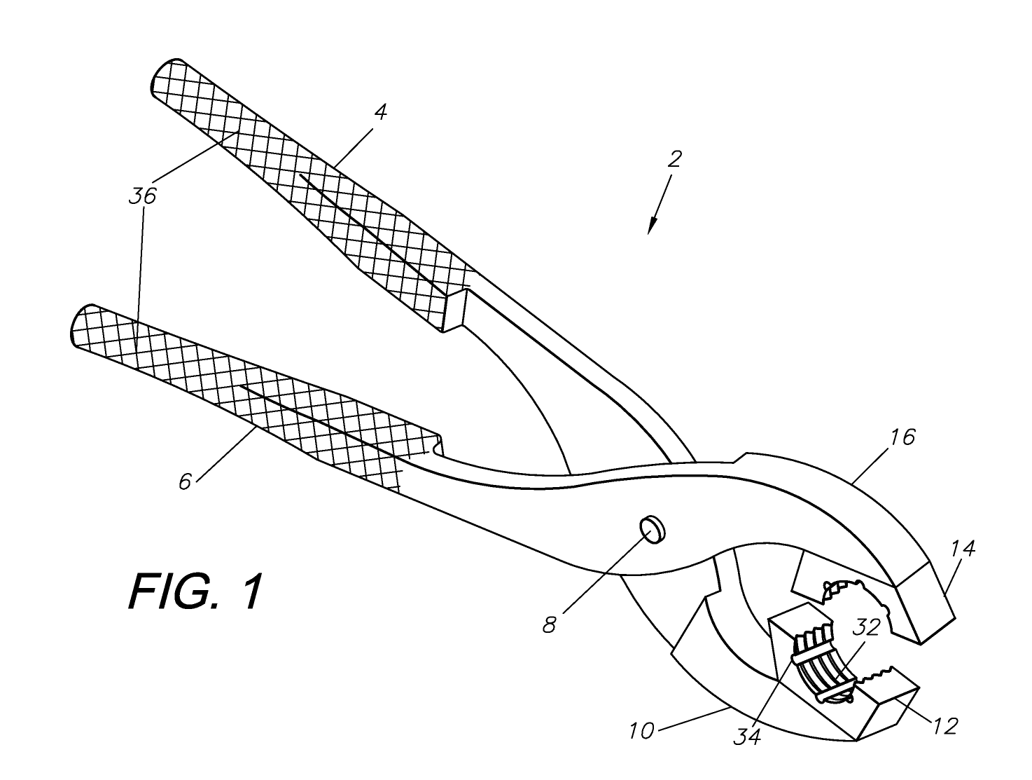

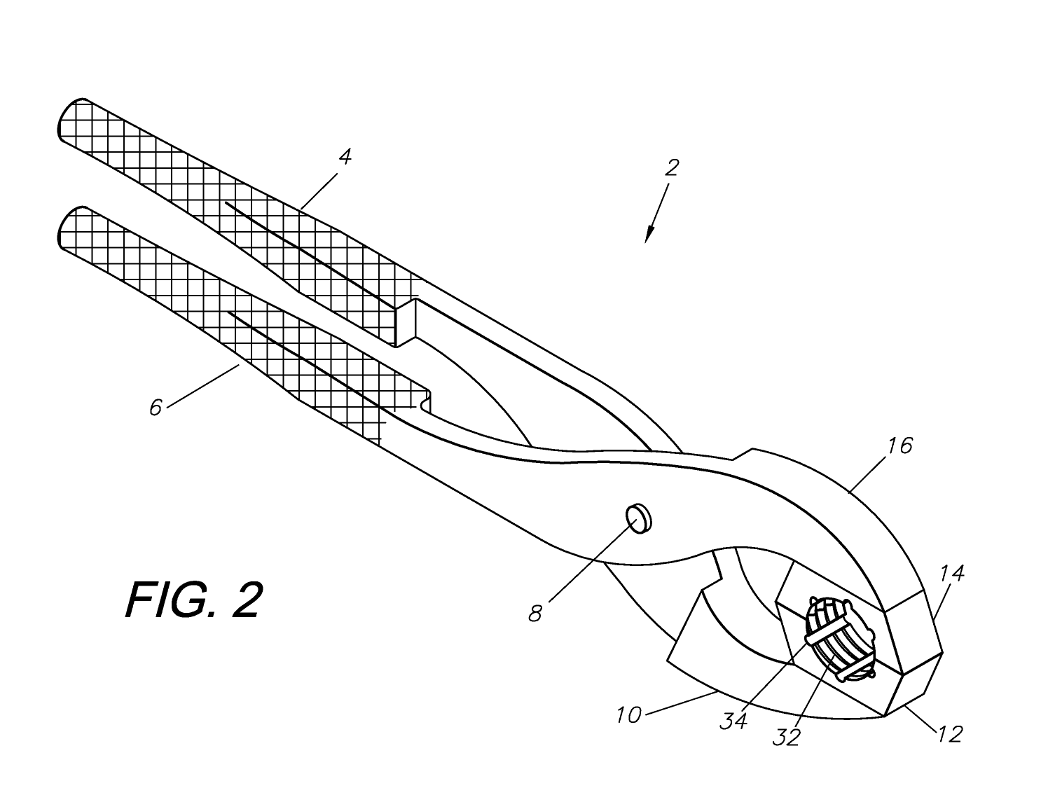

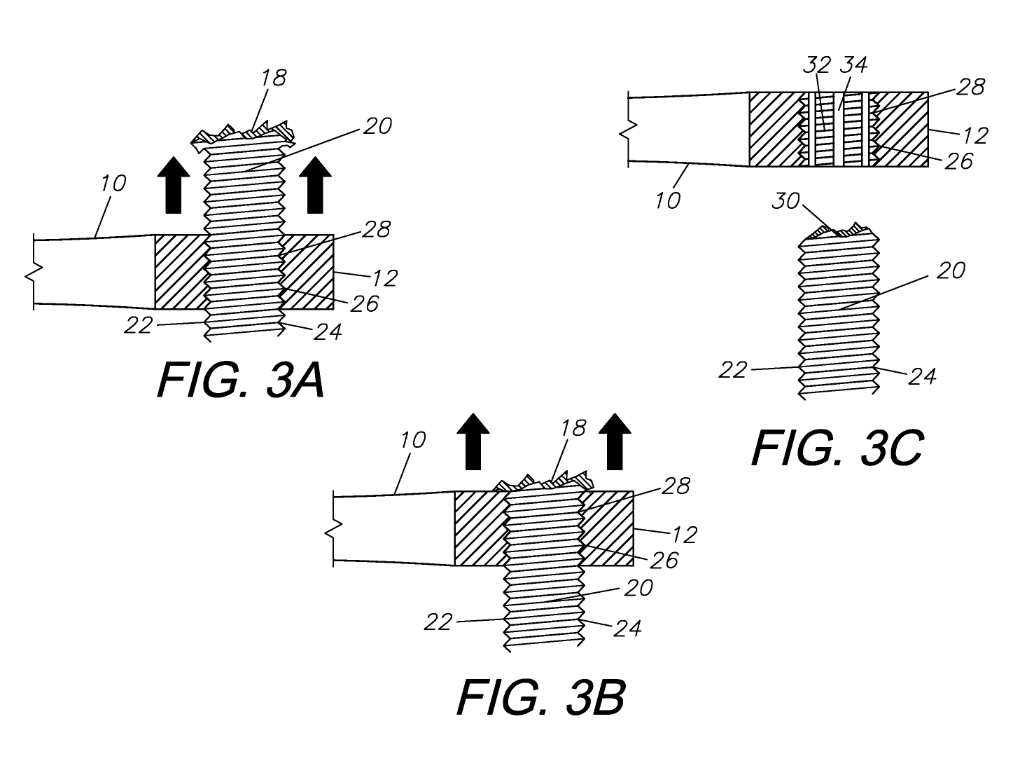

The thread chaser 2 can be opened by pulling the handles 4, 6 apart to separate the dies 12, 14 as seen in FIG. 1. The thread chaser 2 can be closed by pulling the handles 4, 6 together as seen in FIG. 2. FIG. 3A is a cross-sectional view of the lower die 12 and lower jaw portion of the thread chaser 2 when it is in a closed position and engaged with a thread 20 having a damaged end 18. The lands 22 and grooves 24 of the thread 20 fit into the lands 26 and grooves 28 of the thread chaser 2. With the handles 4, 6 held together to keep the dies 12, 14 clamped onto the threads 20, the thread chaser 2 is then rotated. FIG. 3B shows the thread chaser 2 moving up the thread 20 as it is rotated and beginning to repair the damaged portion 18. As the thread chaser 2 repairs and cleans the damaged portion 18 of the thread 20, the pieces of the thread 20 that are removed fall out of the debris channels 34. FIG. 3C shows the thread 20 with a repaired end 26.

### IV. Alternative Embodiment or Aspect of the Thread Chaser 102

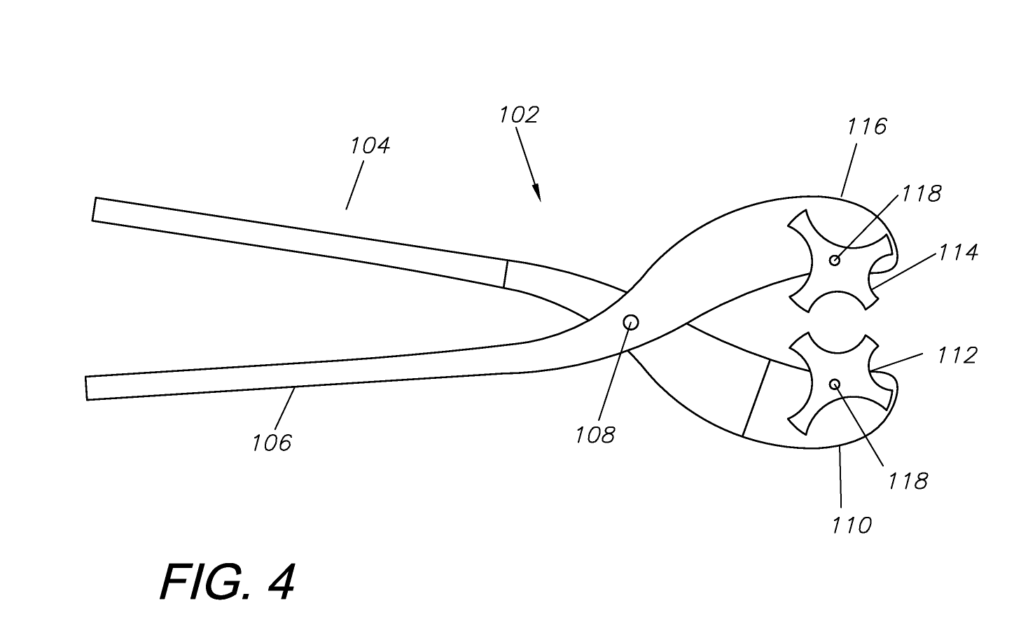

FIG. 4 shows an adjustable wrench thread chaser 102 comprising upper and lower hingedly connected handles 104, 106; upper and lower jaws 116, 110; and upper and lower dies 114, 112. The upper and lower adjustable dies 114, 112 can be rotated about pivot pins 118 to change the diameter of the thread chaser 102 in order to repair different sizes of bolts, rods and other threaded objects. Threaded seats are included for use with threaded objects of multiple sizes and/or shapes.

The thread chaser 102 operates in a similar manner to the wrench thread chaser 2 by pulling the handles 104, 106 together to clamp the dies 112, 114 around a thread. The thread chaser 102 is then rotated around the thread while the handles 104, 106 are held together.

### V. Alternative Embodiment or Aspect of the Thread Chaser 202

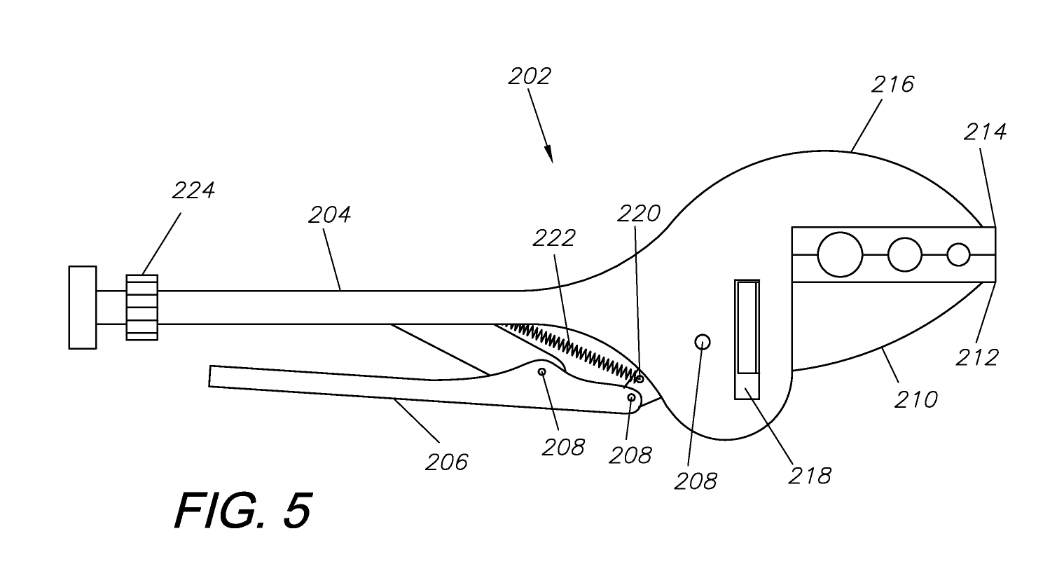

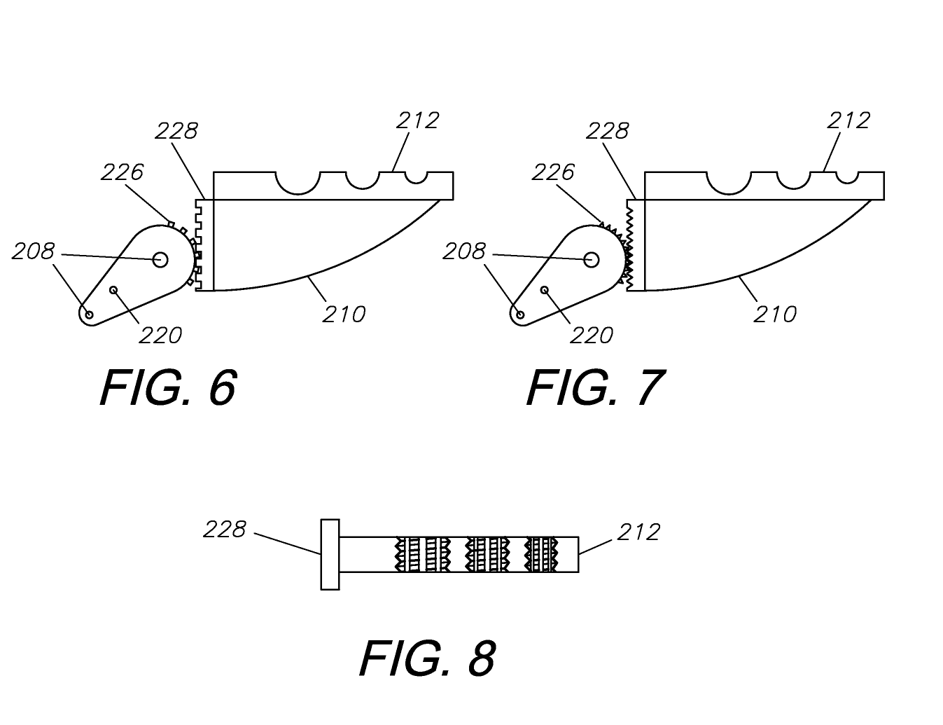

FIG. 5 shows a thread chaser 202 comprising upper and lower handles 204, 206; pivot pins 208; upper and lower jaws 216, 210; upper and lower die blocks 214, 212; a jaw traverse slot 218; a retracting spring mounting hole 220; and a retracting spring 222. The die blocks 214, 212 house several different size dies to allow for the repair of multiple sizes of threads. FIGS. 6 and 7 show a rack 228 and a pinion 226. The rack 228 is connected to the lower die block 212 and the lower jaw 210. When the lower handle 206 is squeezed, the rack 228 and the pinion 226 move the lower jaw 210 and the lower die block 212 upwardly towards the upper die block 214 and the upper jaw 214.

The parallel pliers thread chaser 202 operates in a similar manner to the previous embodiments. The lower handle 206 is squeezed towards the upper handle 204, which clamps the adjustable dies 112, 114 around a thread. The handles 206, 204 are locked by turning the locking nut 224 and the thread chaser 202 is then rotated around the thread.

### VI. Alternative Embodiment or Aspect of the Thread Chaser 302

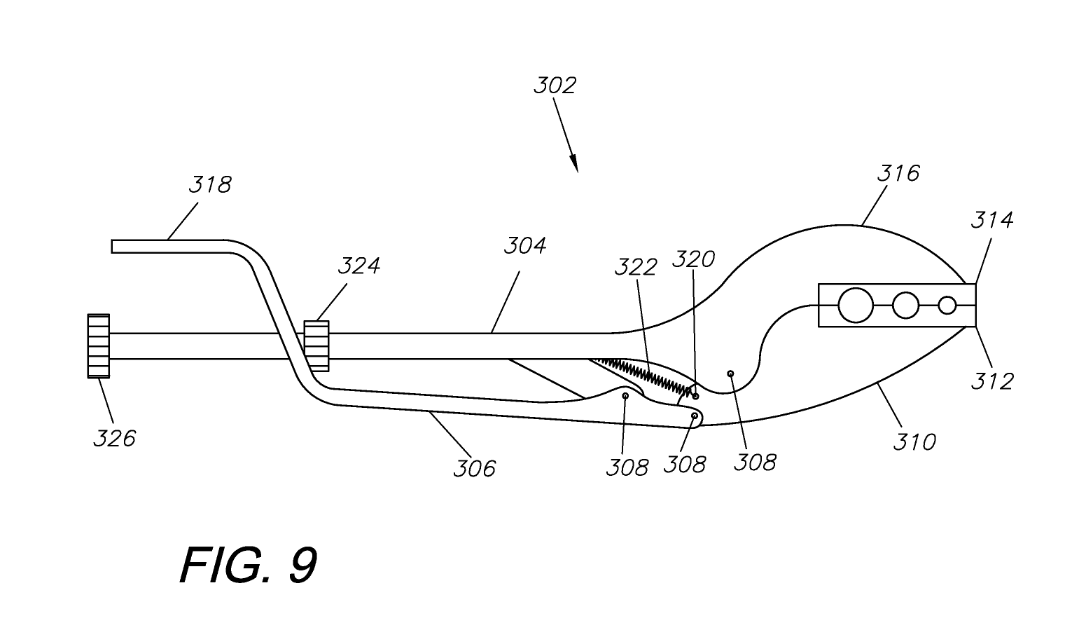

FIG. 9 shows a locking pliers thread chaser 302 in the closed position. The thread chaser 302 comprises an upper handle 304; a lock grip 306; a release grip 318; pivot pins 308; upper and lower jaws 316, 310; upper and lower die blocks 314, 312; a retracting spring mounting hole 320; a retracting spring 322; a locking nut 324; and a knob 326. The die blocks 314, 312 house several different sizes of dies to allow for the repair of multiple sizes of threads.

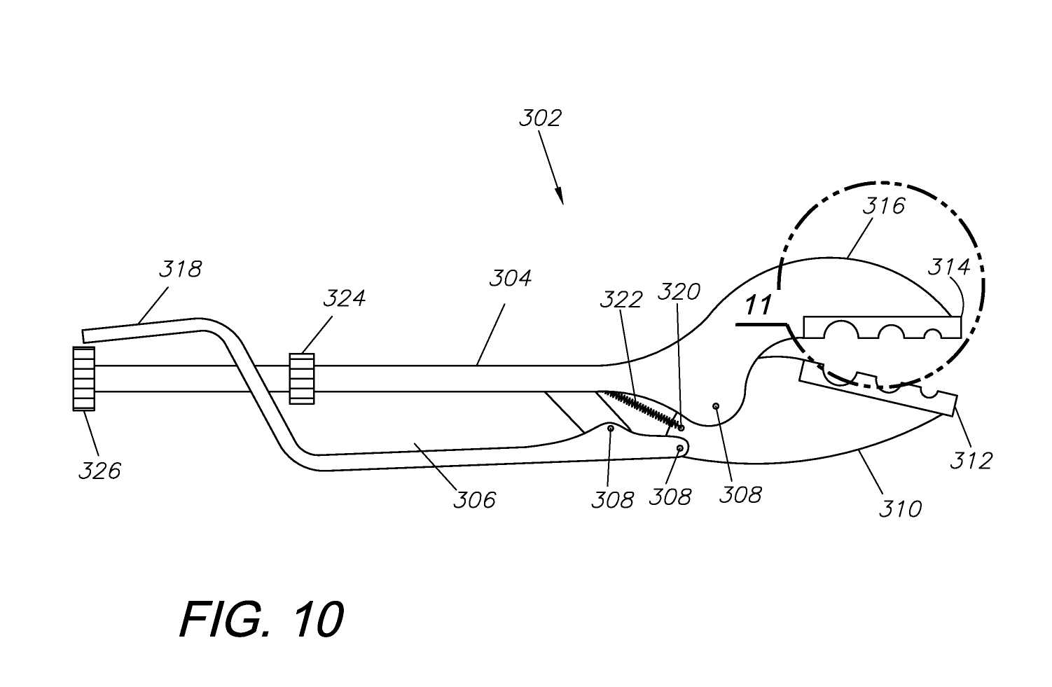

The thread chaser 302 can be clamped around a thread by squeezing the lock grip 306 and locking the lock nut 324. The thread chaser 302 is then rotated around the thread to repair it. After the thread has been repaired, the thread chaser 302 can be released from the thread by unlocking the lock nut and squeezing the release grip 318 to separate the die blocks 312, 314 as seen in FIG. 10. The release grip 318 can engage the knob 326 which prevents a violent movement of the lock grip 306 when released under extreme pressure.

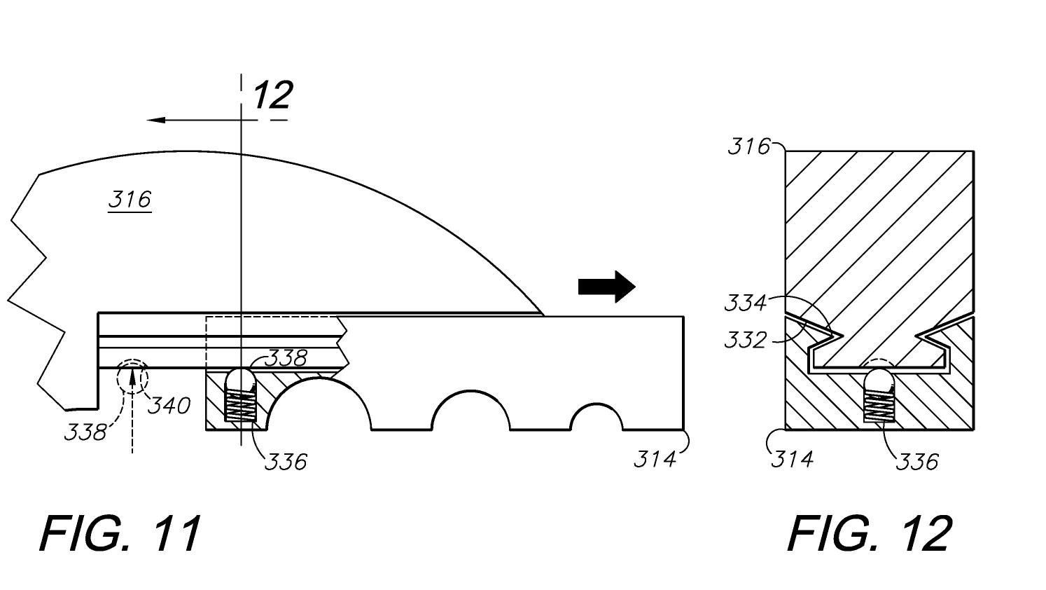

As shown in FIGS. 11-12, the jaws 310, 316 can removably mount the dies 312, 314. The jaws 310, 316 can include V-shaped grooves 332, which slidably receive respective rails 334 formed in the jaws 310, 316. The dies 312, 314 are releasably retained on the jaws 310, 316 by ball detent fasteners comprising balls 338 biased by compression springs 336 into detents 340.

### VI. Alternative Embodiment or Aspect of the Locking pliers 402

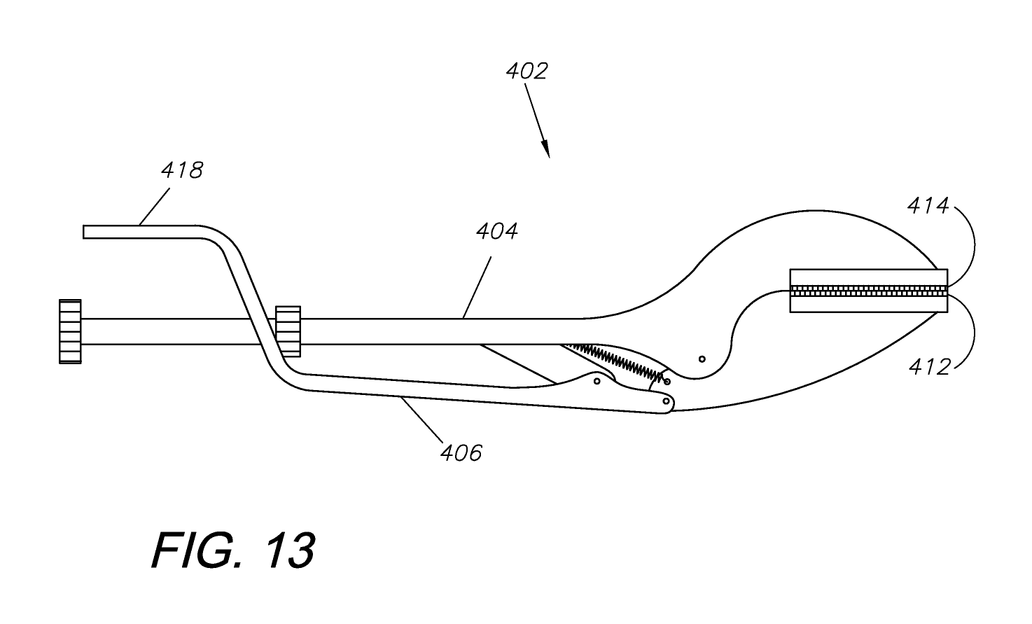

FIG. 13 shows a pair of locking pliers 402 similar to the thread chaser 302 described above but with teeth 412, 414 instead of die blocks. The locking pliers 402 operate in the same way by squeezing the lock grip 406 to clamp the teeth 412, 414 together and squeezing the release grip 418 to unclamp the teeth 412, 414.

It is to be understood that while certain aspects of the invention have been shown and described, the invention is not limited thereto and encompasses various other embodiments and aspects. For example, the thread chasers can accommodate various standard thread configurations, such as SAE, metric, coarse thread (CT), tapered, etc.

Having thus described the invention, what is claimed as new and desired to be secured by Letters Patent is:

1. A thread chasing apparatus comprising:
an upper handle;
a lower handle connected to the upper handle by a connecting hinge;
said upper handle terminating in a first jaw and said lower handle terminating in a second jaw, said jaws adapted for receiving a threaded object;
said upper and lower handles being capable of opening and closing said first and second jaws about said connecting hinge, thereby grasping or releasing said threaded object;
whereby said tool is capable of rotating about said threaded object when said upper and lower jaws are closed; and
whereby said damaged threads located on said threaded object are cleaned, cleared, and repaired.

2. The thread chasing apparatus of claim 1, wherein said first and second jaws include respective first and second threaded portions with teeth adapted for receiving the threads of said threaded object.

3. The thread chasing apparatus of claim 1, wherein said tool is adjustable to receive and repair threaded objects of varying sizes.

4. The thread chasing apparatus of claim 3, further comprising:
said first jaw comprising a first adjustable die and said second jaw comprising a second adjustable die; and
said first and second adjustable dies each including a plurality of threaded seats, each of said threaded seats being adapted for receiving a threaded object.

5. The thread chasing apparatus of claim 3, further comprising:
said first jaw including an upper die block and said second jaw including a lower die block;
a plurality of threaded die sets of different sizes, each said die set including respective upper and lower die blocks, and each said die block including a threaded seat with a plurality of teeth adapted for receiving the threads of said threaded object.

6. The thread chasing apparatus of claim 5, further comprising:
said first jaw including a mounting rail;
said second jaw including a mounting rail; and
wherein said upper and lower die blocks are adapted for being removeably mounted on said mounting rails of said first and second jaws respectively.

7. The thread chasing apparatus of claim 6, further comprising:
said first jaw including a jaw transverse slot, and said second jaw being adapted for sliding engagement with said jaw traverse slot;
said lower handle being connected to said second jaw via a rack and pinion connection;
said lower handle including a mounting hole and a retracting spring mounted in said mounting hole and connected to said upper handle; and
said upper handle including a locking nut adapted for locking said first and said second jaws in a closed position whereby said lower die block is immediately adjacent to said upper die block.

8. The thread chasing apparatus of claim 7, further comprising:
said lower handle including a lock grip and a release grip;
said upper handle including an extendable knob adapted for receiving said lower handle lock grip;
wherein said first jaw and second jaw may be locked in a closed position with said upper die block directly adjacent to said lower die block by placing pressure on said lock grip; and
wherein said first jaw and second jaw may be unlocked and returned to an open position by placing pressure on said release grip.

9. The thread chasing apparatus of claim 6, wherein said upper and lower dies are retained onto said mounting rails via ball detent fasteners biased by compression springs mounted into detents contained within said rails.

10. A thread chasing apparatus comprising:
a tool including an upper handle connected to a lower handle by a connecting hinge;
said upper handle terminating into a first jaw and said lower handle terminating into a second jaw, said jaws adapted for receiving a threaded object, wherein said threaded object includes damaged, dirty, or clogged threads;
said first and second jaws each including at least one threaded die adapted for receiving the threads of said threaded object;
said jaws being further adapted to receive threaded objects of varying shape, size, and diameter;
said upper and lower handles being capable of opening and closing said first and second jaws about said connecting hinge, thereby grasping or releasing said threaded object;
whereby said tool is capable of rotating about said threaded object when said upper and lower jaws are closed; and
whereby said damaged threads located on said threaded object are cleaned, cleared, and repaired.

11. A thread chasing apparatus comprising:
a tool including an upper handle connected to a lower handle by a connecting hinge;
said upper handle terminating into a first jaw and said lower handle terminating into a second jaw, said jaws adapted for receiving a threaded object, wherein said threaded object includes damaged or clogged threads;
an upper die block removeably mounted to said first jaw and a lower die block removeably mounted to said second jaw;
said upper and lower die blocks containing a plurality of threaded dies, and each of said threaded seats including a plurality of teeth adapted for receiving the threads of said threaded object;
said upper and lower handles being capable of opening and closing said first and second jaws about said connecting hinge, thereby grasping or releasing said threaded object;
said upper handle including a locking nut adapted for locking said first and said second jaws in a closed position, wherein said lower die block is immediately adjacent to said upper die block;
whereby said tool is capable of rotating about said threaded object when said upper and lower jaws are closed; and
whereby said damaged threads located on said threaded object are cleaned, cleared, and repaired.

12. The thread chasing apparatus of claim 11, further comprising:
said first jaw including a jaw traverse slot, and said second jaw slidingly engaged with said jaw traverse slot;
said lower handle being connected to said second jaw via a rack and pinion connection; and
said lower handle including a retracting spring mounted to a mounting hole and to said upper handle.

13. The thread chasing apparatus of claim 12, further comprising:
said lower handle including a lock grip and a release grip;
said upper handle including an extendable knob adapted for receiving said lower handle lock grip;
wherein said first jaw and second jaw may be locked in a closed position with said upper die block directly adjacent to said lower die block by placing pressure on said lock grip; and
wherein said first jaw and second jaw may be unlocked and returned to an open position by placing pressure on said release grip.
